(19) United States
(12) Patent Application Publication
(10) Pub. No.: US 2011/0179956 A1
(43) Pub. Date: Jul. 28, 2011

(54) Frozen Food Item Separation Tool

(76) Inventor: Andrew Julien Keith, Wheatley (CA)

(21) Appl. No.: 12/694,232

(22) Filed: Jan. 26, 2010

(51) Int. Cl. A47J 43/00; B26B 13/00; B26D 1/00

(52) U.S. Cl. 99/537; 30/312; 83/13

(57) ABSTRACT

A frozen food item separation tool for separating individual frozen food items from a frozen food item stack. The frozen food item separation tool comprises an upper lever, including wedge-shaped portion, and a lower lever, which is pivotally attached to the upper lever.

### CROSS-REFERENCES TO RELATED APPLICATIONS

This application claims the benefit of provisional patent application No. 61/291,856, filed 2010 Jan. 1 by the present inventor.

### FEDERALLY SPONSORED RESEARCH

None

### SEQUENCE LISTING

None

### BACKGROUND

1. Field

This application relates to food preparation devices, specifically to a novel tool for separating individual frozen food items from a frozen stack of food items in preparation for cooking.

2. Prior Art

Currently people have difficulty while attempting to separate individual frozen food items from a frozen stack in preparation for cooking. Common procedures for separating frozen food items would include the use of knives, chisels, screwdrivers, hammers, and guillotine type mechanisms including blades, and the like. Due to the complicated and somewhat awkward operation of these mechanisms, attempts to separate frozen food items can result in physical injury to persons attempting the task. More often, utilizing these means may result in the contamination of the food items. Devices for cutting, chopping and impacting, different food products, having various designs and configurations incorporating various blade-type or hammer-type apparatus have been disclosed in the prior art, for example, U.S. Pat. Nos. 3,780,436; 4,811,642; 5,899,133; US 2004/0016127 A1; and US 2007/0256305 A1, disclose various cutting, chopping and impacting apparatus and devices.

Other procedures may include defrosting an entire stack of frozen food items in order to make separation easier. This method is also undesirable and for sanitary reasons, the thawed unused portion of the food should not be refrozen. In addition some frozen food item producers provide specific preparation instructions on their packaging, which directs the consumer to cook from frozen.

There remains a need for a quick, safe and easy to use frozen food item separation tool that will provide such characteristics as the ability to operate it with a single hand, ambidextrous operation. The separation tool should also provide the capability to separate all varieties of frozen food items and patties, for example, chicken breasts and chicken patties, turkey breasts and turkey patties, beef patties, vegetable patties and a variety of food items and the like. Those skilled in the art have previously failed to provide or produce an effective solution and therefore there remains a need for a quick, safe, easy to use, portable, hand-held separation tool for separating frozen food items from a frozen stack in preparation for cooking.

### SUMMARY

In accordance with one embodiment, a frozen food item separation tool comprises an upper lever including wedge-shaped portion, and a lower lever, which is pivotally attached to the upper lever.

### DRAWINGS

### Figures

In the drawings, closely related figures have the same number but different alphabetic suffixes.

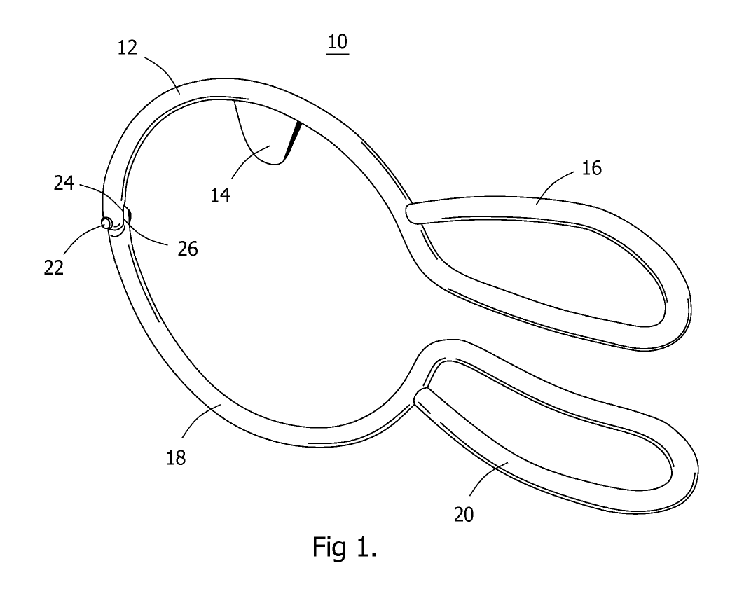

FIG. 1 shows a perspective view illustrating various aspects of a frozen food item separation tool in accordance with one embodiment.

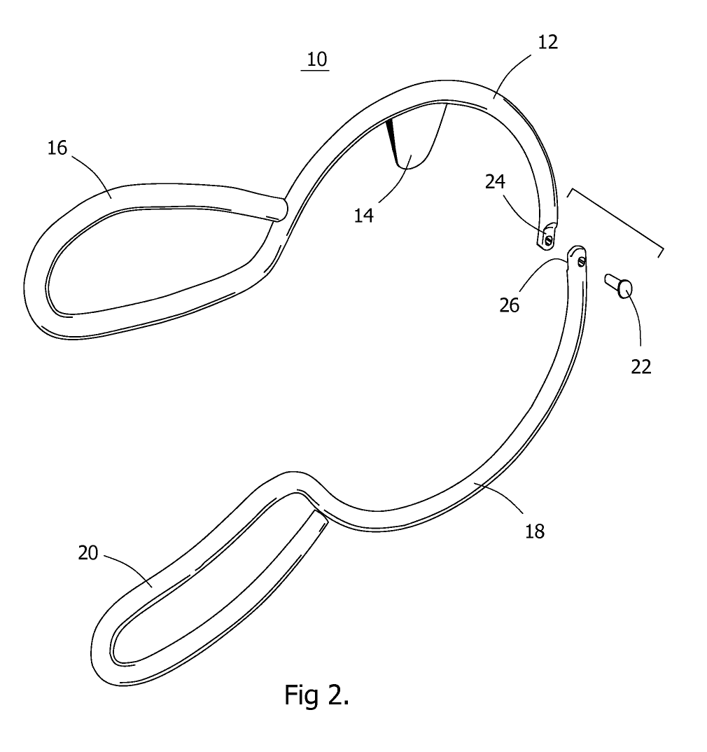

FIG. 2 shows an exploded view illustrating individual parts of a frozen food item separation tool in accordance with one embodiment.

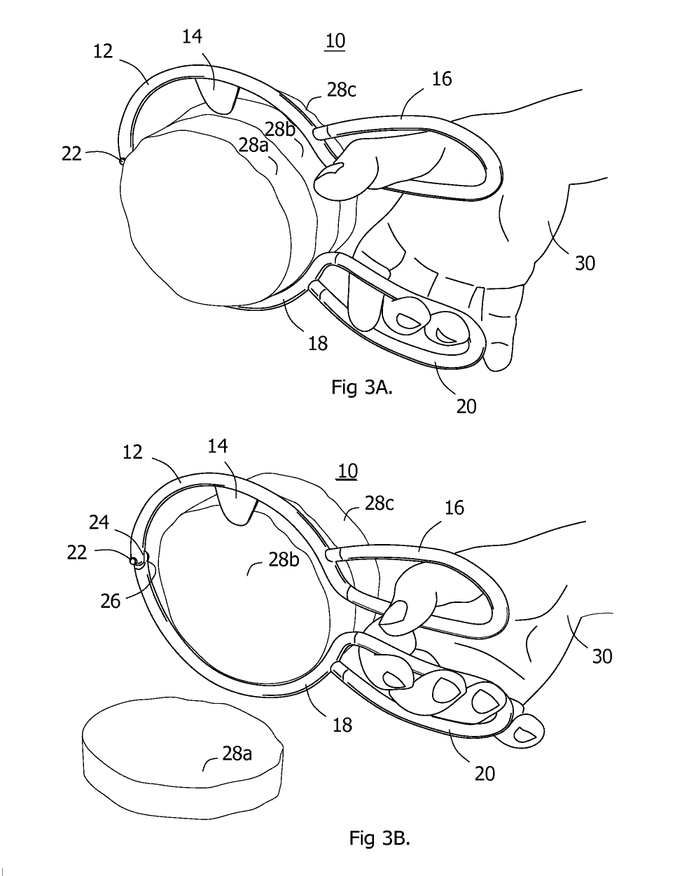

FIG. 3A shows a perspective view of a frozen food item separation tool during operation in an open position in accordance with one embodiment.

FIG. 3B shows a perspective view of a frozen food item separation tool during operation in a closed position in accordance with one embodiment.

### REFERENCE NUMERALS

10 a frozen food item separation tool
12 an upper lever
14 upper lever wedge-shaped portion
16 upper lever handle portion
18 a lower lever
20 lower lever handle portion
22 a pivot pin
24 upper lever pivot seat and aperture portion
26 lower lever pivot seat and aperture portion
28a-28c frozen food items
30 operator

### DETAILED DESCRIPTION

### FIG. 1 and FIG. 2—Embodiment

One embodiment of a frozen food item separation tool is illustrated in FIG. 1 (perspective) and FIG. 2 (exploded view).

FIG. 1 (perspective), a frozen food item separation tool 10, comprises a lower lever 18, and an upper lever 12, that are pivotally attached by a pivot pin 22.

Lower lever 18, is comprised of a lower lever handle portion 20, and a lower lever pivot seat and aperture portion 26. Lower lever handle portion 20 is looped to allow for a person to comfortably insert and grasp the lower handle portion with their fingers during operation of the tool. Lower lever pivot seat and aperture portion 26 allows for the insertion of pivot pin 22. The portion of lower lever 18, between lower lever handle portion 20, and lower lever pivot seat and aperture portion 26 is shaped in a manner that provides a relatively open area and will allow the separation tool to encompass a frozen stack of food items around their outer perimeter during operation.

Upper lever 12 comprises an upper lever handle portion 16, an upper lever pivot seat and aperture portion 24, and an upper lever wedge-shaped portion 14. Upper lever handle portion 16 is looped to allow for a person to comfortably insert and grasp the upper handle portion with their thumb during operation of the tool. Upper lever pivot seat and aperture portion 24 allows for the insertion of pivot pin 22, providing a means for both the lower and upper levers to pivot in relation to each other. Thus resulting in a pivotal connection. The portion of upper lever 12, between upper lever handle portion 16, and upper lever pivot seat and aperture portion 24 is also shaped in a manner that provides a relatively open area and will allow the separation tool to encompass a frozen stack of food items within this area around the stacks outer perimeter during operation.

Fixed to upper lever 12, within the relatively open area between the levers is upper lever wedge-shaped portion 14. Upper lever wedge-shaped portion 14, is curved. The curve of wedge-shaped portion 14, is opposite to the outward shape of the upper lever. The taper of wedge-shaped portion 14, decreases in width as it protrudes away from the upper lever handle 12, into the relatively open area between the upper and lower levers. The more narrow edge of wedge-shaped portion 14, is relatively blunt or dull to the touch. The wedge-shaped portion 14, has two opposed sides that converge relative to each other away from the upper lever 12.

I presently contemplate the levers of one embodiment to have a circular cross section and all parts comprise stainless steel. However a variety of materials could be used such as steel, aluminum, plastic, etc which may be of any cross-sectional profile such as round, square, oval, triangular, etc.

FIG. 2 (exploded view) In addition to the description provided above, FIG. 2 illustrates frozen food separation tool 10, in an open or ready position. FIG. 2 illustrates all parts in a detached or disassembled arrangement, which includes an unobstructed view all parts including upper lever pivot seat and aperture portion 24, of upper lever 12, lower lever pivot seat and aperture portion 26, of lower lever 18, and pivot pin 22.

### Operation

### Embodiment—FIGS. 3A and 3B

FIG. 3A (perspective), illustrates a frozen food item separation tool 10, during operation. During operation of the tool the operator 30, inserts their fingers into the looped area of lower lever handle portion 20, and their thumb into the looped area of upper lever handle portion 16. This will allow the operator to grasp and operate the tool during use. Once the tool is in hand, the operator can open it when desired.

In order to open the separation tool to allow it to be positioned for operation the operator moves their thumb away from their fingers in a hand opening type motion. This hand action pivots both lower lever 18, and upper lever 12, away from each other, each pivoting about pivot pin 22, in turn providing a relatively open area between the levers, thus allowing the operator to position the frozen food item separation tool 10, relative to, and encompassing a frozen stack of food items. The tool is then more precisely positioned to the desired location in relation with the frozen stack where wedge-shaped portion 14 would be more directly in line with the joint where two frozen food items are attached.

FIG. 3A, illustrated frozen food items 28a, 28b, and 28c. With the upper lever wedge-shaped portion 14, of upper lever 12, in the desired position where food items 28a and 28b, are joined together. Frozen food item separation tool 10, may then be engaged and closed to complete the separation of the two chosen food items.

FIG. 3B (perspective), illustrates the frozen food item separation tool 10, upon completion of separation process, where food items 28a, and 28b have been separated. This is completed by way of the operator 30, moving their thumb towards their fingers in a hand closing type motion. This hand action provides the necessary pressure to upper lever handle portion 16, and lower lever handle portion 20, in turn pivoting both lower lever 18, and upper lever 12, about the pivotal connection at upper lever pivot seat and aperture portion 24 and lower lever pivot seat and aperture portion 26 in relation to their pivotal attachment, provided by pivot pin 22.

The operator's hand squeezing action provides the necessary force required to complete the separation process. The levers pivot toward one another about their pivotal connection. During the pivoting movement lower lever 18, relatively provides a means for holding the tool in place in relation to the frozen stack while upper lever wedge-shaped portion 14, is pressed between the two frozen items 28a, and 28b. The increasing width of the wedge-shaped portion causes the food items to move apart from each other quickly resulting in separation of the frozen food items 28a, and 28b. The operator may repeat this process until the desired amount of food items are separated from a frozen stack in preparation for cooking. At present I believe that this embodiment operates most efficiently, however other embodiments may also be satisfactory.

### Advantages

From the description above, a number of advantages of my frozen food item separation tool become evident:

(a) A frozen food item separation tool that is quick and easy to use, lightweight, portable and easy to store.

(b) A separation tool that is hand-held and designed for use with a single hand, and also allows for ambidextrous operation.

(c) A separation tool that is safe to operate, the wedge-shaped portion, which can be relatively blunt or dull to the touch and complete the task.

(d) A separation tool requiring a relatively low degree of strength to operate and complete the task of frozen food item separation.

(e) A separation tool which is easy to manufacture at low cost from materials such as, stainless steel, steel, aluminum, plastic, and the like.

### CONCLUSION, RAMIFICATIONS, AND SCOPE

Accordingly the reader will see that, according to one embodiment of the present invention, I have provided a frozen food item separation tool representing a considerable improvement over prior means and methods to achieve the desired results of separating frozen food items. The embodiment is able to achieve the desired results in a quick, safe, and easy manner. Furthermore the separation tool has additional advantages in that it provides for an ambidextrous, and single-handed operation. Also the frozen food separation tool is lightweight, portable, easy to store, and easy to manufacture at low cost.

While the description contains specifics, these should not be construed as limitations on the scope of embodiments, but as exemplifications of the presently preferred embodiments thereof. Many other ramifications and variations are possible within the teachings of the various embodiments. For example, pivot pin 22, may be eliminated should one of the two levers comprise a notch, loop or relative shape for which the remaining or opposing lever could be pivotally attached. Pivot pin 22, may also be eliminated if either lever comprised a protruding element enabling it to connect to the remaining or opposing lever. Pivot pin 22, may also be eliminated by upper lever 12, and lower lever 18, having been pivotally attached by means of a spring that would allow both levers to automatically open in relation to one another. Use of a spring for pivotally connecting the levers would also allow them to open or rests at a predetermined position for operation. Pivotal attachment of the levers by means of a spring would also allow for the handle portions of each lever to be shaped differently possibly reducing and or eliminating the looped shape of both upper lever handle portion 16, and lower lever handle portion 20. Upper lever wedge-shaped portion 14, may also be provided in many different shapes which may include square, triangular etc. Upper lever wedge-shaped portion 14, may even be provided as a non-wedged-shaped portion, possibly a flat section with parallel surfaces, which may also include a beveled edge. Upper lever wedge-shaped portion 14, could be associated with its adjacent elements in a different manner, for example it could be comprised within other locations of upper lever 12, or in other various locations on lower lever 18. Upper lever wedge-shaped portion 14, may be eliminated if the cross section of the material comprising the levers was for example triangular or similarly forming a wedge in itself. The wedge-shaped portion may be created by simply removing a relative portion of a lever resulting in the remainder of the lever forming a wedge-shaped cross-section. The outward shape of both levers may be incrementally bent to predetermined angles for example relatively hexagonal, octagonal, etc. The relative shape of the levers is not limited so long as it allows the separation tool to encompass a frozen stack of food items around the frozen food item stack perimeter during the separation process.

Any portion or section of the separation tools parts may also be made individually and conventionally attached to one another, in any form and, they may comprise any suitable materials. The parts of the preferred embodiment would be stainless steel. However they may also comprise any acceptable material such as steel, aluminum, plastic, and the like. Thus the scope of the invention should be determined by the appended claims and their legal equivalents, and not by the examples given.

1. A frozen food item separation tool for separating individual frozen food items from a frozen stack of food items, comprising:
a. a lower lever, comprising a lower lever handle portion, a lower lever pivot seat and aperture portion, and
b. an upper lever, comprising an upper lever handle portion, a wedge-shaped portion, an upper lever pivot seat and aperture portion, and
c. a pivot pin for pivotally attaching said lower lever to said upper lever,
whereby said frozen food item separation tool will separate said individual food items from said frozen stack of food items.

2. The frozen food item separation tool of claim 1 wherein said frozen food item separation tool is made of a material selected from the group consisting of stainless steel, steel, aluminum, and plastic for ease of manufacturing, cleaning, and reuse.

3. The frozen food item separation tool of claim 1 wherein said pivotal attachment is a pivot pin.

4. The frozen food item separation tool of claim 1 wherein said wedge-shaped portion is curved.

5. The frozen food item separation tool of claim 1 wherein said wedge-shaped portion has two opposed sides that converge relative to each other away from the upper lever.

6. The frozen food item separation tool of claim 1 wherein said frozen food item separation tool is hand-held for operation.

7. The frozen food item separation tool of claim 1 wherein said lower lever handle portion is looped to allow for a person to comfortably insert and grasp the lower handle portion with their fingers during operation of the tool.

8. The frozen food item separation tool of claim 1 wherein said upper lever and said lower lever are shaped in a manner that will allow the separation tool to encompass a frozen stack of food items around their outer perimeter during operation of the separation tool.

9. The frozen food item separation tool of claim 1 wherein said lower lever handle portion, and said upper lever handle portion are looped to allow for a person to comfortably insert and grasp said tool with their fingers and thumb during operation.

10. A frozen food item separation tool for separating individual frozen food items from a frozen stack of food items, comprising:
a. means for moving a wedge-shaped portion of an upper lever; wherein said means for moving said wedge-shaped portion of said upper lever includes pivotal attachment of said upper lever to a lower lever,
whereby said frozen food item separation tool will separate said individual frozen food items from said frozen stack of food items.

11. The frozen food item separation tool of claim 10 wherein said frozen food item separation tool is made of a material selected from the group consisting of stainless steel, steel, aluminum, and plastic for ease of manufacturing, cleaning, and reuse.

12. The frozen food item separation tool of claim 10 wherein said pivotal attachment is a pivot pin.

13. The frozen food item separation tool of claim 10 wherein said wedge-shaped portion is curved.

14. The frozen food item separation tool of claim 10 wherein said wedge-shaped portion has two opposed sides that converge relative to each other away from the upper lever.

15. The frozen food item separation tool of claim 10 wherein said frozen food item separation tool is hand held for operation.

16. The frozen food item separation tool of claim 10 wherein said lower lever handle portion is looped to allow for a person to comfortably insert and grasp the lower handle portion with their fingers during operation of the tool.

17. The frozen food item separation tool of claim 10 wherein said upper lever and said lower lever are shaped in a manner that will allow the separation tool to encompass a frozen stack of food items around their outer perimeter during operation of the separation tool.

18. The frozen food item separation tool of claim 10 wherein said lower lever handle portion, and said upper lever handle portion are looped to allow for a person to comfortably insert and grasp said tool with their fingers and thumb during operation.

19. A method of separating individual frozen food items from a frozen food item stack, comprising the steps of:
a. providing a frozen food item separation tool that comprises a first lever including a wedge-shaped portion, a second lever that is pivotally attached to said first lever, and
b. positioning said wedge-shaped portion of said first lever where two frozen food items are joined, and
c. applying a squeezing force from an operator to said levers, causing said levers to pivot towards one another, imparting force to said wedge-shaped portion thus urging said wedge-shaped portion between said frozen food items,
thereby said individual frozen food items will be separated from said frozen stack of frozen food items.
